(19) United States
(12) Patent Application Publication
(10) Pub. No.: US 2011/0221148 A1
(43) Pub. Date: Sep. 15, 2011

(54) APPARATUS FOR INDUCING SLEEP IN BABIES

(76) Inventor: Stephen Annese, Montvale, NJ (US)

(21) Appl. No.: 12/719,970

(22) Filed: Mar. 9, 2010

(51) Int. Cl. B62B 3/00

(52) U.S. Cl. 280/47.34

(57) ABSTRACT

An apparatus for inducing a baby to sleep is described. A baby is placed on the apparatus. The apparatus is moved back and forth by a parent or a caregiver. The rhythmic movement, the vibration induced from the contact of the apparatus with the floor, and the sound of the movement operate in conjunction to induce the baby to sleep and/or to sooth the baby. The apparatus includes a platform. The platform includes a base with a lower base surface and an upper base surface. The platform holds or supports a cushion that is removably positioned on the upper base surface. Wheels are engaged to the lower base surface of the platform. A handle extends from the platform. The handle is hingedly engaged to the platform. The handle is retractable with respect to the platform.

### FIELD OF THE INVENTION

The present invention relates to an apparatus for inducing a baby to sleep.

### BACKGROUND OF THE INVENTION

Inducing sleep in babies and infants may prove difficult. Adjusting to days/nights, schedule changes, colic, sickness, and other influences may make it difficult for the baby to fall asleep. Parents with a baby who is not sleeping will attempt nearly anything to get the baby to sleep. For example, parents may drive the babies in cars in order to soothe them and induce sleep. Parents may place the babies in expensive and cumbersome mechanical swings in order to induce sleep. Parents may place the babies beneath a ceiling fan so that the baby can watch the ceiling fan in order to induce sleep.

Unfortunately, many of these existing techniques for inducing sleep do not solve the problem of getting the baby to sleep in the appropriate location. For example, a baby who is a passenger in a car may only remain sleeping while the car is moving. Moreover, fuel will be wasted, and the baby will be exposed to an unnecessary risk of an auto accident. Further, mechanical swings are not designed for a baby to sleep for extended periods of time therein. Moving the sleeping baby from the mechanical swing or from the car seat of the car to the bed or crib may wake the baby.

### SUMMARY OF INVENTION

An apparatus for inducing a baby to sleep is described. A baby is placed on the apparatus. The apparatus is moved back and forth by a parent or a caregiver. The rhythmic movement, the vibration induced from the contact of the apparatus with the floor, and the sound of the movement operate in conjunction to induce the baby to sleep and/or to sooth the baby. After the baby has fallen asleep, the parent or caregiver may transfer the baby to its crib or bed to continue sleeping.

The apparatus described herein induces the baby to sleep and/or soothes the baby. The apparatus provides a removable cushion to aid in the transfer of the baby to its crib or to its bed. The apparatus may be rolled on the floor while the apparatus supports the baby. The rolling action induces sleep in the baby. The cushion may be detached or removed from the apparatus in order to move the baby to its bed or crib.

The apparatus for inducing the baby to sleep includes a platform. The platform comprises a base with a lower base surface and an upper base surface. The platform holds or supports a cushion that is removably positioned on the upper base surface. The cushion supports the baby. Wheels are engaged to the lower base surface of the platform. A handle extends from the platform. The handle is hingedly engaged to the platform. The handle is also retractable with respect to the platform.

The use of the apparatus will now be described. The apparatus is placed on the floor. The baby that needs to fall asleep is placed face up on the cushion. The cushion is already removably positioned on the upper base surface of the platform. The parent or caregiver grasps the handle and pulls the rolling platform in the direction toward the parent or caregiver and then pushes the rolling platform, via the handle, in the opposite direction away from the parent or caregiver. This process is repeated until the baby has fallen asleep.

After the baby has fallen asleep, the cushion (with the baby thereon) may be removed from the apparatus, and the cushion and the baby are carried together to its bed. At the bed or crib, the cushion may be slightly tilted and the baby is urged or scooted off of the cushion and onto the bedding surface. As such, the baby and the cushion may be simultaneously removed from the platform and the baby may then be transferred to a bed or a crib. Alternatively, the baby may be picked up from the cushion and carried to the bed or the crib.

When the apparatus is not in use, the handle be may be retracted into or under the apparatus for convenient storage. The apparatus is lightweight, so the apparatus may easily be stored on a shelf.

In a further aspect, the apparatus may be designed to move back and forth automatically. The apparatus utilizes a rechargeable battery and a small electric motor to drive the wheels to propel the apparatus.

### BRIEF DESCRIPTION OF DRAWINGS

FIG. 1 is a perspective view of the apparatus for inducing a baby to sleep with a baby positioned thereon

FIG. 2 is a perspective view of the apparatus for inducing a baby to sleep.

FIG. 3 is an exploded perspective view of the apparatus for inducing a baby to sleep.

FIG. 4 is a top view of the apparatus for inducing a baby to sleep.

FIG. 5 is a bottom view of the apparatus for inducing a baby to sleep.

FIG. 6 is a handle end view of the apparatus for inducing a baby to sleep.

FIG. 7 is a further handle end view of the apparatus for inducing a baby to sleep with the handle extended.

FIG. 8 is a side view of the apparatus for inducing a baby to sleep.

FIG. 9 is a further side view of the apparatus for inducing a baby to sleep with the handle extended.

FIG. 10 is a cross-sectional view of the front of the apparatus for inducing a baby to sleep.

FIG. 11 is a cross-sectional side view of the apparatus for inducing a baby to sleep.

FIG. 12 is a cross-sectional view of the wheel mount of the apparatus for inducing a baby to sleep.

FIG. 13 is a view of the handle and the bracket.

FIG. 14 is an end view of the embodiment with motorized casters.

FIG. 15 is a side view of the embodiment with motorized casters.

### DETAILED DESCRIPTION OF EMBODIMENTS

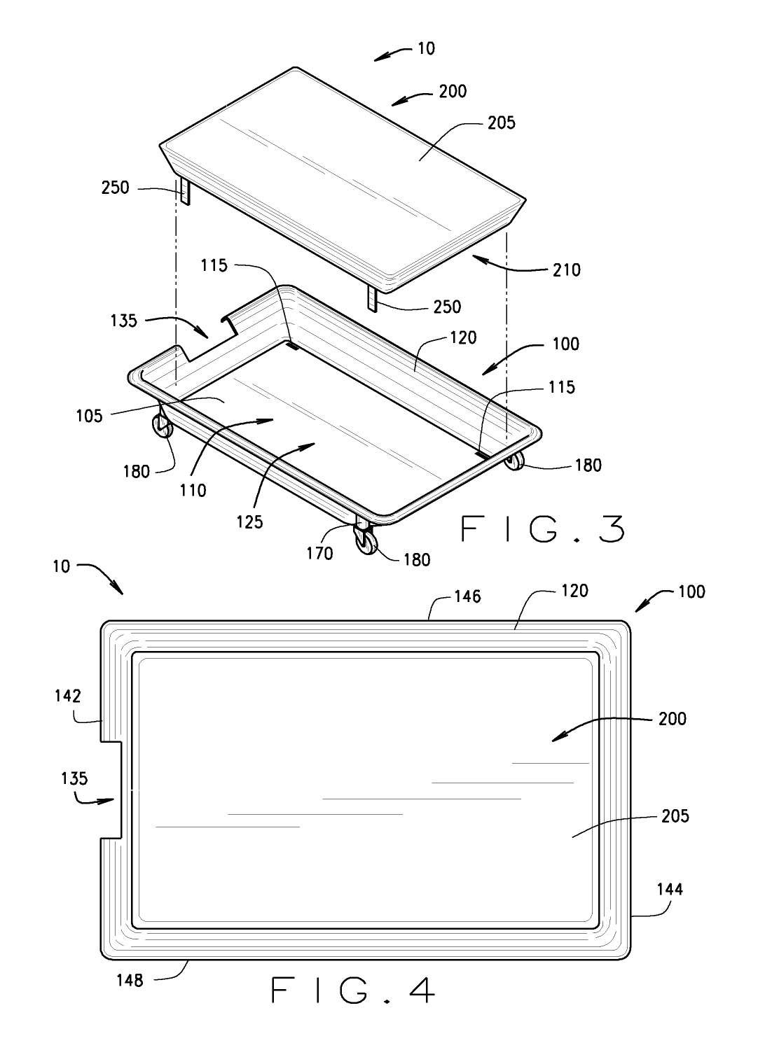

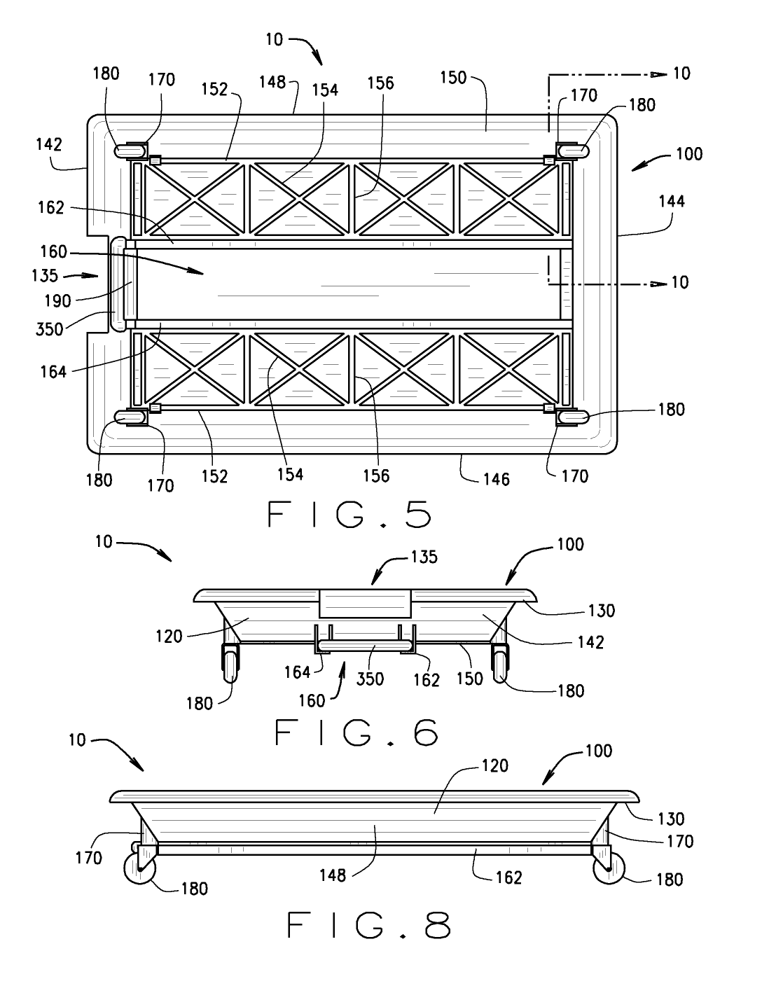

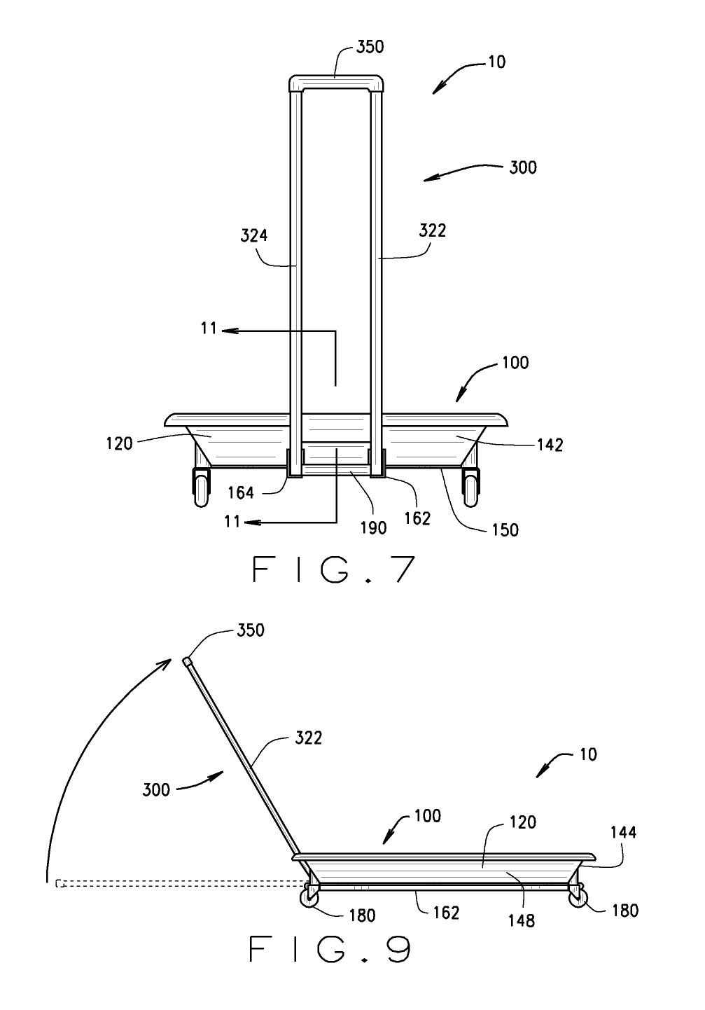

An exemplary embodiment of an apparatus for inducing a baby to sleep is shown in FIGS. 1 through 13. A roller device 10 comprises a platform 100, a cushion 200, and a handle 300. The cushion 200 rests on the platform 100. The handle 300 extends from the platform 100.

As shown in FIG. 1, a baby 50 is placed on a top surface 205 of the cushion 200. A bottom surface 210 of the cushion 200 rests on the platform 100. When it is desired for the baby 50 to sleep or the baby 50 needs soothing, the baby 50 is placed on the top surface 205 of the cushion 200, which is resting on the platform 100. The parent or caregiver grips the handle 300 and moves the roller device 10 in a back and forth motion on a floor 70. The baby 50 is maintained approximately at or just above ground level.

The platform 100 has a generally rectangular shape. The platform 100 includes a base 105. Sidewalls 120 extend from the base 105 to form a receiving area for the cushion 200. The sidewalls 120 terminate in a rolled lip 130. The rolled lip 130 provides a bumper structure or buffering surface for the roller device 10 in case the roller device 10 is accidentally pushed or urged against a wall, table, door jam, etc. Further, the rolled lip 130 acts as a means for the parent or caregiver to grip the roller device 10 and pick up the roller device 10.

The cushion 200 rests on an upper base surface 110 of the base 105 of the platform 100. The sidewalls 120 and the base 105 form a recess 125 that receives the cushion 200. Preferably, the sidewalls 120 extend above a height of the cushion 200 in order to maintain the cushion 200 in the recess 125 and to further act as a rim-like structure to keep the baby 50 from rolling out of or turning out of the platform 100. The cushion 200 rests on the base 105. Specifically, the bottom surface 210 of the cushion 200 rests on the upper base surface 110 of the base 105.

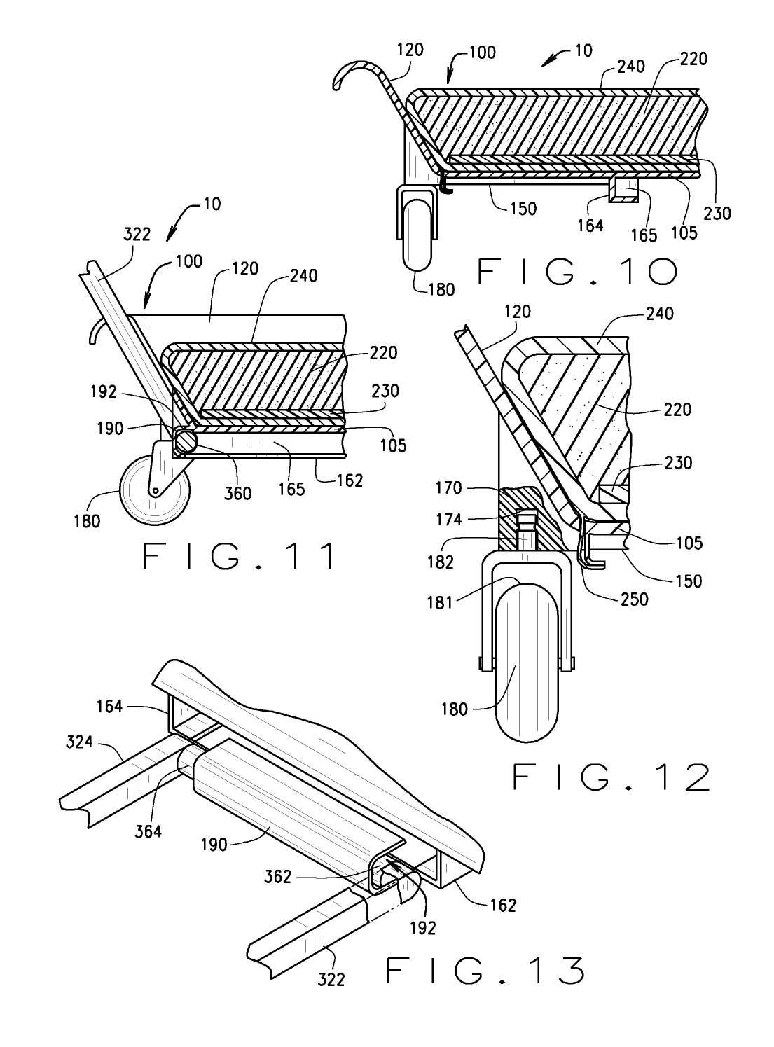

The cushion 200 generally comprises a cushion layer 220 mounted on or integral to a rigid cushion base 230. A partial sectional view of the cushion 200 is shown in FIG. 10. An outer layer 240 surrounds or envelops the combination of the cushion layer 220 and the rigid cushion base 230. The cushion layer 220 may be made from a foam pad or other cushioning structure or resilient material. For example, a 2-inch thick foam pad may be used as the cushion layer 220. The rigid cushion base 230 may include a hard sheet of plastic material or other rigid material upon which the cushion layer 220 is placed, glued, adhered, or attached. The rigid cushion base 230 provides support to the cushion 200 when the cushion 200 is removed from the roller device 10 with the baby 50 thereon. The rigid cushion base 230 prevents the cushion 200 from collapsing or folding in from the weight of the baby 50 such that cushion 200 with the baby 50 thereon may be carefully carried to its bed or crib. As such, the cushion 200 readily separates from the roller device 10.

The outer layer 240 may include a vinyl material that resists moisture and stains. The outer layer 240 may include a zipper or other fastening means to close the outer layer 240 about the combination of the cushion layer 220 and the rigid cushion base 230. A removable, washable cover may be applied over the outer layer 240. For example, a microfiber, cotton, or synthetic blend sham, fitted sheet, or casing may be fitted over the cushion 200.

Velcro tabs 250 extend from the cushion 200. The Velcro tabs 250 pass through tab openings 115 (shown in FIG. 3) in the base 105. The Velcro tabs 250 assist in maintaining the position of the cushion 200 upon the upper base surface 110.

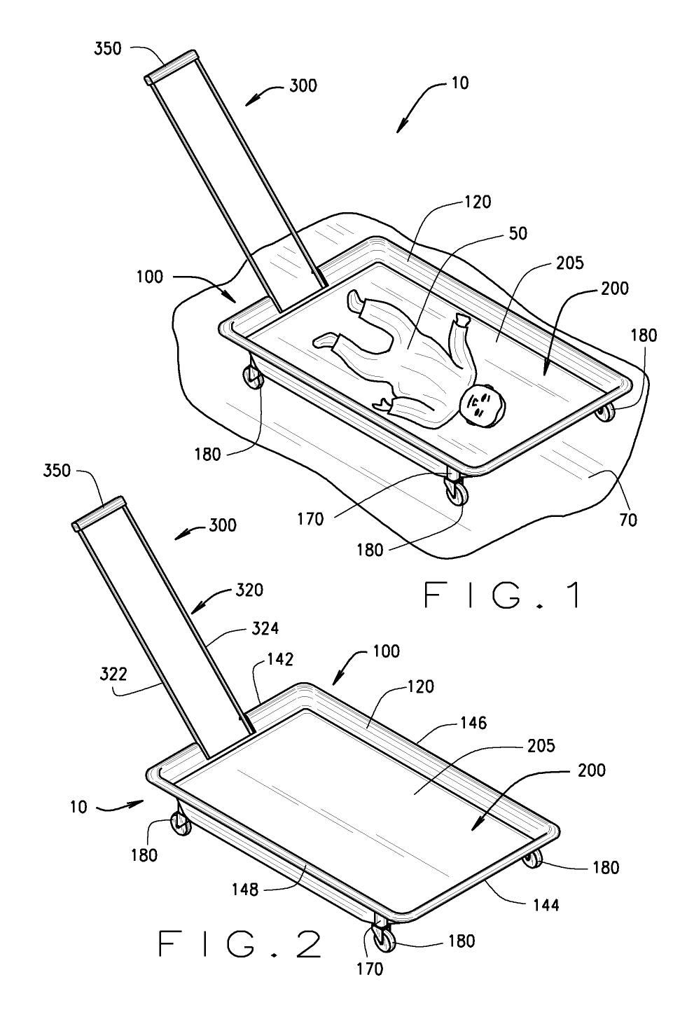

With reference to FIG. 2, the handle 300 extends from a first side 142 of the platform 100. The platform 100 includes a second side 144 opposite of the first side 142. The first side 142 and the second side 144 form the shorter sides of the generally rectangular platform 100. A third side 146 and fourth side 148 form the longer sides of the generally rectangular platform 100. The handle 300 includes handle extensions 320 that hold, form, attach, or define a grip 350. Opposite of the grip 350, the handle extensions 320 include, attach to, or form a bar 360 that is in a hinged connection with the platform 100. The handle 300 extends from the platform 100 in a hinging engagement with respect to the platform 100. As such, the handle 300 first extends from the platform 100 until reaching a hinging engagement with the platform 100.

The hinging engagement allows the parent or caregiver to remain stationary while manipulating the roller device 10 in a back and forth manner. The handle 300 typically elevates when the roller device 10 is pulled toward the parent, and the handle 300 typically lowers when the roller device 10 is pushed away from the parent. The handle 300 is also in a retractable engagement with the platform 100. The handle 300 may fully or nearly fully retract underneath the platform 100 to provide for easier storage.

As shown in FIGS. 5, 11, and 13, the lower base surface 150 is provided with a track 160 to receive the bar 360 and the handle extensions 320 of the handle 300. The bar 360 is held in a pivoting engagement with a bracket 190 of the platform 100. The bracket 190 may be integral or attached to the platform 100. The bracket 190 is in open communication with the track 160 to allow the bar 360 and the handle extensions 320 to slide into and in the track 160 in order to conceal the handle extensions 320 or to mostly conceal the handle extensions 320. With reference to FIGS. 11 and 13, the bracket 190 defines an open space 192 that captures the bar 360 and prevents the handle 300 from being fully removed from the platform 100. The track 160 defines a void 165 that receives the handle extensions 320.

The track 160 comprises oppositely disposed track members 162 and 164 that span approximately 40% to approximately 95% of the length of the lower base surface 150. The track members 162 and 164 are disposed generally parallel to each other with a space between the track members 162 and 164.

The handle 300 comprises the handle extensions 320 connected to the bar 360. The handle extensions 320 have a generally linear shape. The handle extensions 320 are formed of a material with sufficient rigidity to cause the platform 100 to be pushed and pulled. In the embodiment shown, two handle extensions 320 are disposed in a parallel arrangement. The handle extensions 320 connect to the grip 350 on one end of the handle extensions 320, and the handle extensions 320 connect to the bar 360 on the other end of the handle extensions 320. In the embodiment shown, a first handle extension 322 and a second handle extension 324 connect to the bar 360 and to the grip 350. In other embodiments, the handle 300 may include a telescopic, modular construction, or a single handle extension.

The handle extensions 320 and the bar 360 are slideably engaged to the track 160. The track 160 comprises the bracket 190 in operative engagement with the track 160. The handle extensions 320 and the bar 360 slide along the track 160.

Specifically, first and a second opposing ends 362, 364 of the bar 360 slide in the first track member 162 and in the second track member 164. The first opposing end 362 is connected or integral to the first handle extension 322, while the second opposing end 364 is connected or integral to the second handle extension 324.

With reference to FIG. 13, the first and second opposing ends 362, 364 of the bar 360 slide in the track 160 until the opposing ends 362, 364 of the bar 360 abut or contact the bracket 190. The bracket 190 is positioned at an end of the track 160 on the first side of the platform 100. The bracket 190 prevents the handle 300 from being fully removed from the platform 100. The bracket 190 maintains the bar 360 in a hinged engagement to allow the handle extensions 320 to hinge relative to the platform 100. The bracket 190 maintains the bar 360 in the open space 192 of the bracket 190. The first handle extension 322 and the second handle extension 324 are generally fully retracted from the track 160 before the handle 300 may hinge relative to the apparatus 100.

At the first side 142 of the platform 100, a lip opening 135 is provided in a portion of the rolled lip 130 in order to accommodate the handle 300. The handle 300 hinges in a range of approximately parallel to the floor 70 to approximately 80° relative to the floor 70.

The lower base surface 150 includes support structures to provide rigidity and strength to the platform 100. The platform 100 may be picked up with the baby 50 on the cushion 200. As such, it is important that the platform 100 have sufficient rigidity and strength in order to support the weight of the baby 50 and the cushion 200. As shown in FIG. 5, the lower base surface 150 includes lengthwise support ribs 152, diagonal support ribs 154, and widthwise support ribs 156. The diagonal support ribs 154 connect to the intersections of the lengthwise support rigs 152 and the widthwise support ribs 156. The support ribs 152, 154, and 156 extend from the lower base surface 150. The support ribs, 152, 154, and 156 are disposed on either sides of the track 160. Further support ribs 152, 154, and 156 may be positioned in between the track members 162 and 164.

A plurality of wheels, casters, or rollers are positioned on the bottom of the platform 100 to provide for the rolling action of the roller device 10. As shown in FIG. 5, four wheels 180 are positioned at the four corners of the platform 100. Additional wheels may be added to platform 100 and/or their location varied. With reference to FIG. 12, the wheels 180 include a wheel stem 182 that is inserted into a wheel opening 174 of wheel supports 170. The wheel supports 170 are preferably integral to the platform 100 in order to transfer vibration from the rolling of the wheels 180 through the wheel supports 170, to the platform 100, and to the cushion 200 in contact with the baby 50. The sound and vibration of the rolling also acts to soothe and comfort the baby 50. The sound and vibration is especially soothing when the device 10 is rolled on hard surfaces, such as linoleum or tile floor surfaces.

The wheel supports 170 may include a thicker region of the platform 100 that integrally connects to a combination of the lower base surface 150 and the sidewalls 120. The wheel opening 174 is a hollowed recess or socket that receives the wheel stem 182.

The wheels 180 and wheel stem 182 are preferably short in height in order to maintain the baby 50 close to the floor 70. The closer the baby 50 is to the floor 70, the more vibration is transferred from the rolling of the wheels 180 on the floor 70 to the baby 50. Further, the baby 50 is in a safer position closer to the floor. Preferably, there is no more than approximately 1 to 6 inches between the lower base surface 150 and the floor 70. A top surface 181 of the wheels 180 are approximately flush with the lower base surface 150 or are within several inches of the lower base surface 150.

The platform 100 has the length of approximately 24 inches to approximately 48 inches. The embodiment shown in the Figures has the length of approximately 34 inches, which accommodates most babies and is still short enough in order to provide for convenient storage. The platform 100 has a width of approximately 18 inches to approximately 36 inches. The embodiment shown in the Figures has a width of approximately 22 inches. The platform 100 has a thickness of approximately 1/16 inches to approximately ½ inches. The embodiment shown in the Figures has a thickness of approximately ⅛ inches.

The platform 100 may be formed from plastics and thermoplastics, such as, for example, polypropylene, polyvinyl chloride, polycarbonate, polystyrene, and blends thereof. The platform 100 may be formed through thermoforming, molding, injection molding, and other plastic forming processes known in the art. The platform 100 may be provided in a variety of colors.

The sidewalls 120 extend from the upper base surface 110 at an angle of approximately 110° to approximately 140° (relative to the upper base surface 110) in order to provide the recess 125. In the embodiment shown in the Figures, the sidewalls 120 extend at approximately a 120° angle relative to the upper base surface 110.

The wheels 180 may be a grip ring stem type cartwheel commercially available from Shepherd as Omega Series Part No. PCM 2020 IBC. The handle 300 may be similar to the handle model T10 commercially available by Clipper Products.

In further embodiments, the cushion 200 could be hinged lengthwise for ease in placing the baby 50 into the crib. The lengthwise hinge allows for the cushion 200 to cradle the baby 50 during transfer to the crib.

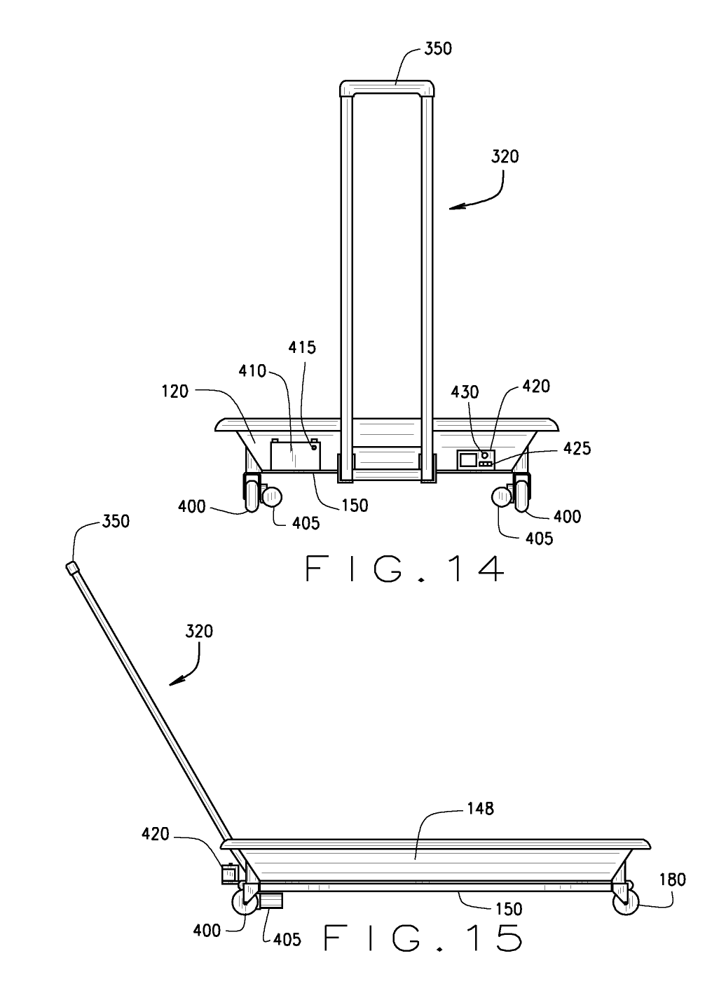

In still further embodiments, as shown in FIGS. 14 and 15, the device 10 includes motorized casters 400 to automatically roll or propel the device 10. One, two, three, four or more of the motorized casters 400 may be positioned on the lower base surface 150 of the platform 100. The motorized casters 400 may also be positioned at one or more of the corners of the platform 100. One or more of the more motorized casters 400 may also be positioned in a central or middle region of the lower base surface 150. A combination of the motorized casters 400 and the wheels 180 may also be used.

The motorized casters 400 include a motor 405 to drive the caster 400. The motorized casters 400 are in electrical and/or control communication with a battery 410 and a controller 420. The battery 410 may include rechargeable batteries that may be recharged by plugging a jack 415 into a source of alternating or direct current. The battery 410 may also be replaceable batteries, such as, for example, dry cell batteries.

The controller 420 includes switches 425 and controls 430 to activate and operate the roller device 10. The controller 420 controls the forward and reverse drive of the casters 400. The controller 420 controls the speed and length of the movement of the motorized casters 400. The speed and length of the movement may adjusted by the user via the switches 425 and the controls 430. The controller 420 signals the motorized casters 400 to drive forward for a distance and then to drive in reverse. Suitable casters 400 include POWERKASTER motorized casters commercially available from Boston Robotics, which use worm gear motors that operates at 12 v or 24 v.

Those skilled in the art will appreciate that variations from the specific embodiments disclosed above are contemplated by the invention. The invention should not be restricted to the above embodiments, but should be measured by the following claims.

What is claimed:

1. An apparatus for inducing a baby to sleep, comprising:
a platform to maintain a baby approximately at or just above ground or floor level;
the platform comprising a base with a lower base surface and an upper base surface;
a cushion to support the baby;
the cushion removably positioned on the upper base surface;
wheels engaged to the lower base surface of the platform to roll the apparatus, wherein
the wheels induce vibration to the platform when the wheels are rolled on the floor or the ground;
the handle extending from the platform; and
the handle hingedly engaged to the platform.

2. The apparatus according to claim 1, wherein the handle retracts into the platform.

3. The apparatus according to claim 1, wherein the cushion comprises a cushion layer, a rigid cushion base, and an outer layer.

4. The apparatus according to claim 1, wherein sidewalls extend from the upper base surface to define a recess that receives the cushion.

5. The apparatus according to claim 4, wherein the sidewalls form a rolled lip.

6. The apparatus according to claim 1, wherein the wheels comprise a wheel stem that are inserted into a wheel opening of a wheel support of the platform.

7. The apparatus according to claim 1, wherein the lower base surface comprises a track, wherein the handle movably engages the track.

8. The apparatus according to claim 1, wherein the lower base surface comprises a first track member and a second track member; wherein the handle comprises a bar; wherein the bar slides in the first track member and in the second track member; wherein the platform comprises a bracket that receives the bar; and wherein the bar pivotally rotates within the bracket.

9. The apparatus according to claim 8, wherein the handle comprises handle extensions extending from the bar; and wherein the handle extensions comprise a grip.

10. The apparatus according to claim 1, wherein the lower base surface comprises a track, support ribs on both sides of the track, and wheel supports at corners of the platform.

11. The apparatus according to claim 1, wherein the handle comprises a first handle extension and a second handle extension connected to a bar; wherein the handle extensions have a generally linear shape; and the handle extensions and the bar are slideably engaged to a track.

12. The apparatus according to claim 11, wherein the track comprises a first track member and a second track member; the track comprises a bracket in operative engagement with the track; the handle extensions and the bar slide along the track; wherein a first opposing end of the bar slides in the first track member and a second opposing end of the bar slides in the second track member until the opposing ends abut or contact the bracket.

13. The apparatus according to claim 1, wherein the lower base surface is approximately 1 to approximately 6 inches from a floor upon which the apparatus is rolling on, and a top surface of the wheels are approximately flush with the lower base surface.

14. The apparatus according to claim 1, wherein the handle hinges relative to the apparatus after the handle is fully extended from the apparatus.

15. The apparatus according to claim 1, wherein the apparatus further comprises one or more motorized casters to propel the apparatus.

16. An apparatus for inducing a baby to sleep, comprising:
a platform;
the platform comprising a base with a lower base surface and an upper base surface;
a cushion, the cushion positioned on the upper base surface;
sidewalls extending from the base to form a recess to receive the cushion;
wheels engaged to the lower base surface of the platform;
the handle extending from the platform, and the handle retractable to a position below the lower base surface;
the handle comprising handle extensions connected to a bar, wherein the handle extensions have a generally linear shape;
the handle extensions and the bar are slideably engaged to a track;
the track comprises a bracket in operative engagement with the track;
the handle extensions and the bar slide along the track; and
the bracket maintains the bar in a pivotal engagement to allow the handle extension to hinge relative to the platform.

17. An apparatus for inducing a baby to sleep, comprising:
a platform;
the platform comprising a base with a lower base surface and an upper base surface;
a cushion, the cushion removably positioned on the upper base surface;
sidewalls extending from the base to form a recess to receive the cushion;
wheels engaged to the lower base surface of the platform;
the handle extending from the platform and the handle retractable to a position below the lower base surface;
the handle comprising a first handle extension and a second handle extension connected to a bar, wherein the handle extensions have a generally linear shape; wherein the bar has opposing ends;
the handle extensions and the bar are slideably engaged to a track, wherein the track comprises a first track member and a second track member;
the track comprises a bracket in operative engagement with the track;
the handle extensions and the bar slide along the track, wherein a first opposing end of the bar slides in the first track member and a second opposing end of the bar slides in the second track member until the opposing ends abut or contact the bracket; and
the bracket maintains the bar in a pivotal engagement with the platform to allow the handle extension to hinge relative to the platform after the first and second handle extensions are retracted from the apparatus.

18. A method for inducing a baby to sleep, comprising:
providing an apparatus, comprising:
a platform, the platform comprising a base with a lower base surface and an upper base surface; a cushion to support a baby, the cushion positioned on the upper base surface; wheels engaged to the lower base surface of the platform;
a handle extending from the platform; the handle hingedly engaged to the platform;
setting the baby on the cushion;
gripping the handle; and
rolling the platform back and forth to induce the baby to sleep.

19. The method according to claim 18, further comprising:
simultaneously removing the cushion and the baby from the platform; and
transferring the baby to a bed or a crib.

20. The method according to claim 18, further comprising:
extending the handle from the platform;
setting the baby on the cushion;
rolling the platform back and forth to induce the baby to sleep;
moving the handle relative to the platform;
causing the platform to vibrate;
transferring the baby to a bed or a crib; and
retracting the handle into the platform.

21. The method according to claim 18, further comprising retracting the handle into a track on the lower base surface of the platform.
